(19) United States
(12) Patent Application Publication
(10) Pub. No.: US 2011/0037979 A1
(43) Pub. Date: Feb. 17, 2011

(54) IMAGING SPECTROGRAPH

(76) Inventors: Petr Straka, Praha (CZ); Martin Divoky, Praha (CZ)

Correspondence Address: NOTARO, MICHALOS & ZACCARIA P.C., 100 DUTCH HILL ROAD, ORANGEBURG, NY, 10962, US

(21) Appl. No.: 12/989,266

(22) PCT Filed: Jun. 4, 2009
(86) PCT No.: PCT/CZ2009/000080

§ 371 Date: Oct. 22, 2010

(30) Foreign Application Priority Data
Jun. 20, 2008 (CZ) PV2008 385

(51) Int. Cl. G01J 3/28

(52) U.S. Cl. 356/326

(57) ABSTRACT

The imaging spectrograph comprises of the first optical system (104), the spectral filter unit, the second optical system (124), and the detector (114). The spectral filter unit comprises of at least one optical filter (110), which position to both optical systems (104, 124) satisfies the conditions zz′=ff′ and zz′=ff′ where z is the distance between the object (102) and the front focal point of the first optical system (104), z′ is the distance between the optical filter (110) and the rear focal point of the first optical system (104), f and f′ are the front and rear focal lengths of the first optical system (104), respectively, Z is the distance between the optical filter (110) and the front focal point of the second optical system (124), z′ is the distance between the photosensitive area of the detector (114) and the rear focal point of the second optical system (124), and f and f′ are the front and rear focal lengths of the second optical system (124), respectively.

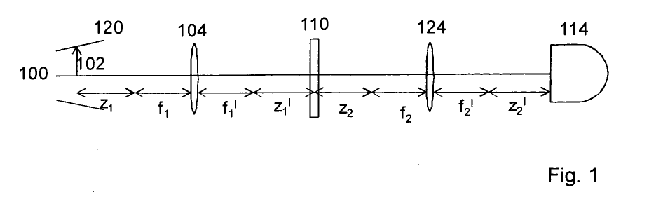

### TECHNICAL FIELD

A solution concerns a spectrograph with two-dimensional or three-dimensional imaging.

### BACKGROUND ART

Simple decomposition of polychromatic optical images of mass objects into spectral, i.e., color, components is used in various devices. One group of such devices uses a matrix of optical filters placed directly onto a photosensitive area of a detector. An example of such devices is consumer's electronics like cameras where every image point is resolved into three spectral components. The main disadvantage of the matrix of the optical filters placed directly on the photosensitive area of the detector is the impossibility to exchange the filters and a limited number of the spectral bands.

Other detectors have optical filters placed outside the photosensitive area of a detector. For a detailed distinction of the spectral content in more than three spectral bands, in addition to special cameras with more spectral channels, imaging spectrographs are used. Optical elements with angular dispersion, with acousto-optic dispersion, and with dispersion of optical rotation (Patents of the Czech Republic No. 284282, 288303) are used to resolve the spectral components of an optical beam, as well as optical filters or the Fourier analysis of the image's autocorrelation.

Often the object or its image is analyzed part by part, i.e., the object plane is scanned point by point, or line by line, and each part of the image is spectrally analyzed with the use of the angular dispersion, for example. Spectral analysis of the object's image part by part is costly and complicated. It utilizes a precise mechanical scanning system, a scanning aperture, a complex setup of a filter unit, and means for precise assembling of the parts of the image. Usually, the highest spectral resolution achievable with interference filters such as a Fabry-Perot resonator is inaccessible.

Sometimes, it is possible to spectrally analyze the entire object or its image without the spatial scanning. Such analysis is done by the imaging spectrographs with the optical filters. By sequential exchange of the various optical filters, the image of the object in the respective spectral component of the beam is obtained. On the other hand, if each of the optical filters has a different optical wedge for the respective analyzed spectral component of the beam, the final image consisting of superimposed images of the spectral components is distorted. It is due to a relative shift of the images of the different spectral components on the detector. The shift is proportional to the wedge angle. The distortion has to be removed subsequently. Sometimes optical filters with a minimized optical wedge are used, which might shift the image on the detector by less than the resolution of the detector and therefore the image distortion would be undetectable. Anyway, such filters are not yet available as easily and in as broad series as the traditional filters with the larger optical wedge are, and their cost is much higher.

### DISCLOSURE OF THE INVENTION

A construction of a spectrograph according to this invention removes the imperfections stated above. The invented spectrograph comprises of an optical imaging system that images an analyzed object plane on a plane of a photosensitive area of a detector and includes an optical filter inserted into the object plane of the imaging system or into an image of the object plane created by imaging between the source of the beam and the detector. Placing the optical filter with an optical wedge into a proper position with respect to the imaged object substantially minimizes or cancels the image distortion during the spectral analysis of the object.

The imaging spectrograph comprises of a first optical system, a spectral filter unit, a second optical system, and a detector. The spectral filter unit comprises of an optical filter, which position to both optical systems satisfies the conditions z₁z₁′=f₁f₁′ and z₂z₂′=f₂f₂′, where z₁ is the distance between the object and the front focal point of the first optical system, z₁′ is the distance between the optical filter and the rear focal point of the first optical system, f₁ and f₁′ are the front and rear focal lengths of the first optical system, respectively, z₂ is the distance between the optical filter and the front focal point of the second optical system, z₂′ is the distance between the detector and the rear focal point of the second optical system, and f₂ and f₂′ are the front and rear focal lengths of the second optical system, respectively.

The first or second optical system may comprise of a mirror, a lens, a telescope, or a photographic objective known as a photographic lens. The spectral filter unit can include a supporting wheel with several optical filters. Other alternative is that the spectral filter unit comprises of two or more supporting wheels with the optical filters. Between every two supporting wheels, it is advantageous to include an optical system with the front focal length f and rear focal length f′ in a way that both distances, the distance z between the optical filters of the previous supporting wheel and the front focal point of the optical system, and the distance z′ between the optical filters of the following supporting wheel and the rear focal point of the optical system, satisfy the condition zz′=ff′. The optical filter can be based on transmission, absorption, diffraction, or reflection of a part of a spectrum of impinging radiation, so that just the analyzed spectral component of the beam gets from the filter to the detector.

A bandwidth of spectral transmission of the optical filter is narrower than the spectrum of the beam and the optical filters are an optical wedge with respect to the beam. The optical wedge is the property of the optical filter that deviates the analyzed spectral component of the optical radiation from its previous direction of propagation before the insertion of the filter.

Filters with an optical wedge other than optical filters can be also used, for example, neutral density filters that attenuate the beam. A spectral bandwidth transmitted by these neutral density filters can be comparable with the spectrum of the beam. A detector of the radiation can be either a detector able to detect power with two-dimensional resolution or a detector with one-dimensional or one-point resolution accompanied by a proper mechanical translation system that allows scanning of the object's image by the photosensitive area of the detector.

It is even possible by a movement of the front focal point of the first optical system that is placed between the object and the first optical filter to change the position of the object plane, while keeping the image of the object on the filter, to obtain a spectral map of the space. The map composes of spectrally analyzed particular object planes. In the case when the optical filter is placed directly in the object plane, the movement of the front focal point of the optical system between the filter and the detector is accompanied by the simultaneous movement of the filter with the object plane, so that both coincide.

### BRIEF DESCRIPTION OF THE FIGURES

There is a set-up schema of the spectrograph and the analyzed object on the accompanying picture.

### EXAMPLE

The imaging spectrograph comprises of the first optical system 104, the spectral filter unit, second optical system 124, and the detector 114. The first optical system 104 comprises of a first achromatic objective and the second optical system 124 comprises of a second achromatic objective. The spectral filter unit comprises of the supporting wheel with a thickness of 5 mm with ten inserted circular transmissive interference optical filters 110 with a diameter of 25 mm, a thickness of 5 mm, a central transmitted wavelength of λᵢ [nm]=700+20*(i−1), where i=1, . . . , 10, and a transmitted spectral bandwidth of 10 nm. Axes of the filters are parallel with the rotation axis of the supporting wheel and in the same distance from the axis of the supporting wheel. The axis of the supporting wheel is parallel with the optical axis 100 in a distance that is equal to the distance between the axis of the wheel and the axes of the filters. The optical filters 110 are inserted into the supporting wheel in a way that the intersection point of incidence and transmitted beam 120 lies in the front plane of the supporting wheel which is nearer to the object 102 that is being imaged. The position of the front plane of the supporting wheel satisfies the conditions z₁z₁′=f₁f₁′ and z₂z₂′=f₂f₂′, where z₁ is the distance between the object 102 and the front focal point of the first achromatic objective, z₁′ is the distance between front plane of the supporting wheel with optical filters 110 and the rear focal point of the first achromatic objective, f₁ and f₁′ are front and rear focal lengths of the first achromatic objective, respectively, z₂ is the distance of the front plane of the supporting wheel with the optical filters HO and the front focal point of the second achromatic objective, z₂′ is the distance between the photosensitive area of the detector 114 and the rear focal point of the second achromatic objective, and f₂ and f₂′ are the front and rear focal lengths of the second achromatic objective, respectively. The detector 114 is a monochrome digital CCD camera.

A beam 120 exiting from its source, which is in this case a Ti: sapphire pulse laser with spectral radiation in the range of 680-900 nm and output power adjusted by optical attenuator filters, is focused by a spherical mirror into the plane, that is perpendicular to the optical axis 100 and represents the object 102. The object plane is then identical with the focal plane of the laser beam 120 and the object 102 that is being imaged is the spatial distribution of the power of the beam Pₚ(x,y,λ) in the focal plane of the spherical mirror which also represents the distribution of the angular spectrum of the beam 120. The object 102 is imaged by the first achromatic objective onto the one of the optical filters 110 inserted into the supporting wheel with the optical filters 110. The filter 110 has the central transmitted wavelength of λ₁. The image of the object 102 on the optical filter 110 is then imaged by the selected spectral component of the beam 120 and the second achromatic objective onto the photosensitive area of the camera which is sensitive to the average power in the analyzed component of the beam 120. At the same time the average power of the beam at the analyzed spectral band is adjusted by the optical attenuator filters to match the dynamic range of the camera. The camera then creates the snapshot of the object 102 as the distribution of the average power of the spectral component of the beam P_{d}(x′,y′,λ₁=const.) on the photosensitive area of the camera with coordinates x′, y′. The optical filter 110 is then exchanged by the rotation of the supporting wheel with the optical filters 110 along its axis. This way the central wavelength of the analyzed component of the beam 120 changes sequentially from the value λ₁ to values λ₂, λ₃, . . . , λ₁₀. For each of the optical filters 110, the snapshot of P_{d}(x′,y′,λᵢ=const.), where i=1, . . . , 10, is taken. By analyzing the set of the snapshots or, more precisely, by evaluating dependence of the position of the centroid and of the axial width of the beam on the central wavelength λᵢ, the spectral dependence (i.e. dispersion) of the direction and divergence of the laser beam 120 is obtained.

### INDUSTRIAL APPLICABILITY

The solution according to this invention has a potential application in spectral or other (e.g. power distribution) analysis of spectral components of beams. The invention can be exploited in areas of optical or physical instruments, in astronomy, aviation, cartography, and biology. This type of imaging spectrograph offers high spectral and spatial resolution.

The invention, illustrated on the measurement of certain properties of the spectral components of the optical beam, makes possible to analyze especially spatial parameters of the components of beams or objects by power or particle detectors.

1. The imaging spectrograph, comprising of the first optical system, the spectral filter unit, the second optical system, and the detector, wherein the spectral filter unit comprises of at least one optical filter (110) which position to both optical systems (104, 124) satisfies the conditions z₁z₁′=f₁f₁′and z₂z₂′=f₂f₂′, where z₁ is the distance between the object (102) and the front focal point of the first optical system (104), z₁′ is the distance between the optical filter (110) and the rear focal point of the first optical system (104), f₁ and f₁′ are the front and rear focal lengths of the first optical system (104), respectively, z₂ is the distance between the optical filter (110) and the front focal point of the second optical system (124), z₂′ is the distance between the photosensitive area of the detector (114) and rear focal point of the second optical system (124), and f₂ and f₂′ are the front and rear focal lengths of the second optical system (124), respectively.

2. The imaging spectrograph according to claim 1 wherein the first optical system (104) is a mirror.

3. The imaging spectrograph according to claim 1 wherein the first optical system (104) is a lens.

4. The imaging spectrograph according to claim 1 wherein the first optical system (104) is a photographic objective.

5. The imaging spectrograph according to claim 1 wherein the first optical system (104) is a telescope.

6. The imaging spectrograph according to claim 1 wherein the spectral filter unit includes a supporting wheel with at least two optical filters (110).

7. The imaging spectrograph according to claim 6 wherein the spectral filter unit comprises of at least two supporting wheels, each of them including at least one optical filter (110), whereas between every two supporting wheels an optical system is included satisfying the condition zz′=ff′, where z is the distance between filters of the previous supporting wheel and the front focal point of the optical system, z′ is the distance between filters of the following supporting wheel and the rear focal point of the optical system, and f and f′ are the front and rear focal lengths of the optical system, respectively.
